(19) United States
(12) Patent Application Publication
(10) Pub. No.: US 2016/0288577 A1
(43) Pub. Date: Oct. 6, 2016

(54) HYBRID REINFORCEMENT

(71) Applicant: CONTINENTAL REIFEN DEUTSCHLAND GMBH, Hannover (DE)

(72) Inventor: Wolfgang Reese, Peine (DE)

(73) Assignee: Continental Reifen Deutschland GmbH, Hannover (DE)

(21) Appl. No.: 15/035,309

(22) PCT Filed: Aug. 28, 2014
(86) PCT No.: PCT/EP2014/068214

§ 371 Date: May 9, 2016

(30) Foreign Application Priority Data
Nov. 19, 2013 (DE) 10 2013 223 573.9

(51) Int. Cl. B60C 9/20; D02G 3/06; D06M 15/693; B60C 9/00; B29C 55/00

(52) U.S. Cl. CPC B60C 9/2009; B60C 9/005; B60C 9/0042; B29C 55/005; D06M 15/693; D02G 3/06; B60C 2009/0078; B60C 2009/0071; B60C 2009/0035; B60C 2009/0092; B60C 2009/0085; B60C 2009/2077; B60C 2009/208; B60C 2009/209; B60C 2009/2096; B29K 2067/00

(57) ABSTRACT

A strength member for elastomeric articles of manufacture, in particular for the belt bandage of a pneumatic vehicle tire, wherein the strength member is a hybrid cord comprising at least one low-modulus yam having a modulus of elasticity of not more than 100 mN/(tex·%) and at least one high-modulus yam having a modulus of elasticity of not less than 200 mN/(tex·%), each to ASTM D885M at an elongation of 3%, wherein all the yams of the hybrid cord are folded together and wherein the hybrid cord is provided an adhesive impregnation.

### CROSS REFERENCE TO RELATED APPLICATIONS

This application is a continuation application of international patent application PCT/EP2014/068214, filed Aug. 28, 2014, designating the United States and claiming priority from German patent application 10 2013 223 573.9, filed Nov. 19, 2013, and the entire content of these applications is incorporated herein by reference.

### FIELD OF THE INVENTION

The invention relates to a strength member for elastomeric articles of manufacture, in particular for the belt bandage of a pneumatic vehicle tire.

### BACKGROUND

This section provides background information to facilitate a better understanding of the various aspects of the disclosure. It should be understood that the statements in this section of this document are to be read in this light, and not as admissions of prior art.

A belt bandage is provided in a pneumatic vehicle tire to prevent expansion of the tire from centrifugal forces during driving, particularly during high-speed operation. A pneumatic vehicle tire in radial design generally comprises an air-impermeable inner layer, a radial carcass which contains strength members and extends from the zenith region of the tire via the side walls into the bead region and there is usually anchored by wrapping around pull-resistant bead cores, a radially external profiled tread strip and a belt between the tread strip and the carcass, said belt being covered radially externally by the belt bandage. The belt bandage may have a single- or multi-ply configuration and covers at least the belt edges. The belt bandage typically contains a parallel arrangement of essentially circumferentially extending strength members in the form of cords embedded in rubber.

In tire production, the belt bandage is applied in the form of plies, strips or single-type strength members comprising strength members embedded in an unvulcanized mixture of rubber which are wound or spooled onto the belt. The strength members are embedded in the rubber by a sheet of essentially parallel thread-shaped strength members, which are generally provided an adhesive impregnation for better adherence to the embedded rubber, passing in the longitudinal direction through a calender or an extruder for sheathing with the rubber mixture.

The strength members of the belt bandage are intended to allow sufficient expansion at the shaping stage and also in the vulcanization mold during tire production in order that the tire may be precision formed, and they are intended to ensure, once the tire is finished, good high-speed effectiveness in operation. To meet these requirements, the strength members should have a breaking extension sufficient for tire manufacture and be extendable up to a strain of about 3% to 4% under a moderate force and to a higher strain only under a very high force.

A very wide variety of cords have already been proposed as strength members for the belt bandage. DE 10 2006 031 780 A1, for instance, proposes strength members of the belt bandage that are hybrid cords constructed of a first yarn made of aramid, having a fineness of ≦840 dtex and folded together with a further yarn, said yarn being made of nylon and having a fineness of ≦940 dtex.

In the hybrid cords for the belt bandage of a pneumatic vehicle tire that are known from DE 10 2007 025 490 A1, the hybrid cord is formed from two twisted yarns, one yarn being an aramid yarn with a fineness of ≦1680 dtex and the second yarn being a PES yarn with a fineness of ≦1670 dtex.

In such a hybrid construction, a high-modulus yarn is twisted with a low-modulus yarn and thereby put on a helical path in order to provide it with scope for geometric elongation in the hybrid cord. This confers an extensibility whereby the modulus of elasticity is relatively small for a small deformation and relatively larger, by comparison, for a larger deformation. A force-elongation behavior of this type permits expansion in tire shaping and tire vulcanization and renders the tire high speed effective.

The exemplary embodiments explicitly reported in the cited documents, however, all merely disclose hybrid cords constructed of yarns having a fineness of not less than 840 dtex each. A reduction in fineness generally leads to reduced strength, and therefore even a comparatively small load may cause breakage of strength members in service or in the course of tire manufacture.

The art is additionally moving in the direction of pneumatic vehicle tires having minimal rolling resistance.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In a first aspect, the invention relates to a strength member for elastomeric articles of manufacture, in particular for the belt bandage of a pneumatic vehicle tire, wherein the strength member is a hybrid cord comprising at least one low-modulus yarn having a modulus of elasticity of not more than 100 mN/(tex·%) and at least one high-modulus yarn having a modulus of elasticity of not less than 200 mN/(tex·%), each to ASTM D885M at an elongation of 3%, wherein all the yarns of the hybrid cord are folded together and wherein the hybrid cord is provided an adhesive impregnation. The invention further relates to a method of producing such a strength member, wherein the strength member is a hybrid cord comprising at least one low-modulus yarn having an modulus of elasticity of not more than 100 mN/(tex·%) and at least one high-modulus yarn having an modulus of elasticity of not less than 200 mN/(tex·%), each to ASTM D885M at an elongation of 3%, wherein all the yarns of the hybrid cord are folded together, wherein an adhesion promoter is applied to the hybrid cord, wherein the hybrid cord is then dried at a temperature of from 100° C. to 200° C., wherein the hybrid cord is hot-drawn at a temperature of from 200° C. to 250° C. after drying, and wherein the hybrid cord relaxes at from 100° C. to 200° C. under a residual stress after hot drawing. The invention further relates to the method of using such a strength member.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure

The problem addressed by the present invention is that of providing a strength member for elastomeric articles of manufacture, in particular for the belt bandage of pneumatic vehicle tires, which on being used in the belt bandage of a pneumatic vehicle tire reduces the rolling resistance of said pneumatic vehicle tire while at the same time ensuring its durability and allowing a trouble-free tire build cum vulcanization. The problem addressed by the present invention is also that of providing a method for producing such a strength member.

The problem is solved when the low-modulus yarn or yarns has or have a cumulative fineness of not more than 550 dtex, preferably a cumulative fineness of not more than 250 dtex, when the high-modulus yarn or yarns has or have a cumulative fineness of not more than 550 dtex, preferably a cumulative fineness of not more than 250 dtex, and when the hybrid cord has a breaking extension of not less than 5%.

A strength member ply comprising such a hybrid cord as strength member is notable for a particularly low level of rolling resistance when used in a pneumatic vehicle tire. The hybrid cord has a lower fineness and thus a lower cross section than hybrid cords of higher fineness. This makes possible the provision of a strength member ply that is notable for a lower thickness. In addition, strength member material and/or rubberization is saved. This reduces hysteresis as well as weight. When used in pneumatic vehicle tires, in particular in the belt bandage, a reduced level of rolling resistance is thus effectuated whilst maintaining the remaining advantageous properties of a hybrid-type strength member. The reduced thickness of rubberization also saves on material costs.

Surprisingly, such hybrid cords of such low fineness were found to have a force-elongation behavior coupled with sufficient strength in the tire where the reduced modulus is compensated by an increased number of cords in the fabric. This ensures adequate durability for a pneumatic vehicle tire comprising such hybrid cords as strength members of the belt bandage and allows a trouble-free tire build vulcanization.

The invention accordingly provides a hybrid cord of low fineness that is very useful as a strength member for elastomeric articles of manufacture, in particular as a strength member for the belt bandage of pneumatic vehicle tires.

An adhesive impregnation which is particularly useful is an RFL dip (resorcinol-formaldehyde latex dip) with which the strength member is dipped for adherence between the rubber and the strength member. The dip can be applied in the 1-bath or 2-bath dip process.

For the purposes of the present invention, “cords” are linear constructs consisting of two or more yarns folded together. A “hybrid cord” is a cord where the two or more yarns folded together differ. A “yarn” herein is in line with DIN 60900 a linear construct consisting of individual filaments or fibers. The filaments or fibers of the yarns are preferably twisted together. A yarn in one material is wholly or partly formed of this material. The fineness of a cord is typically computed as the sum total of the finenesses of the yarns making up the cord.

The “breaking extension” is the elongation at ultimate tensile force, i.e., the elongation at the force which causes the hybrid cord to break. Breaking extension is measured to ASTM D885M.

It is preferable for all the strength members of a strength member ply to be such hybrid cords.

It is also preferable for the high-modulus yarn or yarns of the hybrid cord to have a cumulative fineness of not more than 250 dtex. Preferably, in this embodiment, the cumulative fineness of the low-modulus yarn or yarns have a cumulative fineness of not more than 250 dtex.

It is advantageous for the hybrid cord to comprise a low-modulus yarn in polyester (PES) and/or a low-modulus yarn in polyamide (PA).

The polyester yarn (yarn in PES) of a hybrid cord according to the present invention is an HMLS polyester yarn (High Modulus Low Shrinkage) and/or an HMHS polyester yarn (High Modulus High Shrinkage) and/or an HMNS regular polyester yarn (High Modulus Normal Shrinkage). It is preferably an HMLS polyester yarn and/or an HMNS regular polyester yarn which are/is used. These yarns have a good level of thermal stability, fully in line with requirements in the applications mentioned, e.g., high-speed effectiveness on application in a pneumatic vehicle tire.

Advantageously, the polyester (PES) of a polyester yarn is selected from the group consisting of polyethylene terephthalate (PET) and/or polyethylene naphthalate (PEN) and/or polybutylene terephthalate (PBT) and/or polycarbonate (PC), which may formally be considered a polyester. The use of PEN and/or PET is preferable and that of PET is particularly preferable. PET has an advantage over PEN in that it is comparatively inexpensive. PET polyester is preferably used in the form of HMLS and/or HMNS regular PET.

Advantageously, the polyamide of a yarn in polyamide is selected from the group consisting of polyamide 6 (PA 6) and/or polyamide 66 (PA 66) and/or polyamide 12 (PA 12) and/or polyamide 11 (PA 11) and/or polyamide 1313 (PA 1313) and/or polyamide 4 (PA 4) and/or polyamide 7 (PA 7) and/or polyamide 8 (PA 8) and/or polyamide 9 (PA 9) and/or polyamide 46 (PA 46) and/or polyamide 610 (PA 610) and/or polyamide 612 (PA 612) and/or polyamide 69 (PA 69) and/or polyamide 66/6 (PA 66/6). The use of PA 6 and/or PA 66 is preferable and that of PA 66 is particularly preferable.

If employed in the belt bandage, yarns in PA and yarns in PES contribute to the adverse phenomenon of flatspotting owing to their shrinkage at low elongation. A reduced level of these strength member materials in a strength member ply of a pneumatic vehicle tire thus leads to an improvement in flatspotting resistance and in dimensional stability.

It is advantageous for the hybrid cord to include a high-modulus yarn in aramid and/or a high-modulus yarn in carbon and/or a high-modulus yarn in glass. These materials are very useful as the high-modulus constituent of the hybrid cord. Aramid and carbon are cost intensive to procure. Reducing the level of these strength member materials thus reduces material costs.

In advantageous developments, the hybrid cord is constructed of a yarn in aramid and a further yarn in PES, or of a yarn in aramid and a further yarn in PA. Such a simple cord construction provides a hybrid cord which, when employed in a pneumatic vehicle tire for example, combines the necessary strength with very good flatspotting and rolling resistance properties.

In a preferred development, the hybrid cord comprises an aramid yarn having a fineness of not more than 220 dtex. The employment of such a strength member provides an elastomeric article of manufacture having a strength member ply combining good strength with comparatively low height. This additionally results in low material costs and, on employment in a pneumatic vehicle tire, an optimized level of rolling resistance.

The yarn in aramid preferably has a fineness of 220 dtex. Preferably, a 220 dtex aramid yarn is folded together with a further yarn in PA 66 of 235 dtex fineness or with a yarn in HMLS-PET of 238 dtex fineness. Strength member plies of this type are notable for a particularly low height. Preferably, the aramid yarn may also be folded together with a further yarn in PA 66 of 470 dtex fineness or with a yarn in HMLS-PET of 550 dtex fineness. Hybrid cords of this type are notable for a high breaking extension.

The difference in the finenesses of yarns making up a hybrid cord should be kept to a minimum to obtain a very uniform and symmetrical cord that has good processing properties and a good level of retained strength after fatiguing. It is advantageous for the yarns making up the cord to have a very similar level of fineness. What has been found to be particularly advantageous in this respect is a hybrid cord made up of 220 dtex aramid yarn and a further yarn in PA 66 at 235 dtex and/or a further yarn in HMLS -PET at 238 dtex.

In other advantageous developments, the hybrid cords are constructed of three, four or more yarns folded together. It is preferable for the hybrid cords to be constructed of one or two yarns in aramid and two further yarns, these further yarns both being formed of PES or both of PA or one further yarn of PES and one further yarn of PA.

Advantageously, the yarns of the hybrid cord are folded together using a twist factor α of 80 to 200. This twist factor α is defined as α=twist [number of turns/m]·(fineness [tex]/1000)^{1/2} and is a measure of the turns per meter relative to the fineness of the cord. At α<80, fatigue resistance declines steeply, which can lead to cord breakages. At α>200, by contrast, strength declines steeply, while there is an increasing rising in processing costs. Preferably, the yarns of the hybrid cord are folded together using a twist factor α of from 100 to 150.

For a high breaking extension on the part of the strength member, it is advantageous for the hybrid cord to be hot-drawn under a tensile stress of not more than 60 mN/tex, preferably under a tensile stress of not more than 40 mN/tex. This can take place in the process of adhesive impregnation.

To ensure trouble-free tire building including vulcanization plus good high-speed effectiveness, the modulus of elasticity of the hybrid cord at 3% elongation to ASTM D885M is from 80 mN/(tex·%) to 300 mN/(tex·%), preferably from 100 mN/(tex·%) to 200 mN/(tex·%).

The problem as it relates to the method of production is solved when:

the low-modulus yarn or yarns has or have a cumulative fineness of not more than 550 dtex, preferably a cumulative fineness of not more than 250 dtex,
the high-modulus yarn or yarns has or have a cumulative fineness of not more than 550 dtex, preferably a cumulative fineness of not more than 250 dtex,
the hybrid cord is exposed to a tensile stress of from 5 to 50 mN/tex, preferably to a tensile stress of from 10 mN/tex to 30 mN/tex, during drying, and
the hybrid cord is exposed to a tensile stress of from 10 mN/tex to 60 mN/tex, preferably to a tensile stress of from 15 mN/tex to 40 mN/tex, whilst undergoing hot drawing, and
the hybrid cord relaxes under a tensile stress of from 0 mN/tex to 30 mN/tex, preferably from 3 mN/tex to 15 mN/tex.

A strength member of the present invention is obtainable with such a method. The resulting hybrid cord has a low level of fineness. Surprisingly, such a low-fineness hybrid cord which experiences a very low level of tensile stress in the drying, hot drawing and relaxing phases of the adhesive impregnation process, has a high breaking extension, in particular a breaking extension of not less than 5%. Its breaking extension is higher than that of a comparable hybrid cord but exposed to higher levels of tension stress during the adhesive impregnation process. This makes possible the provision of a strength member for elastomeric articles of manufacture, in particular for the belt bandage of pneumatic vehicle tires, which on using the strength member in the belt bandage of a pneumatic vehicle tire has the low fineness to reduce the rolling resistance of the pneumatic vehicle tire while at the same time safeguarding the durability of the pneumatic vehicle tire and enabling a trouble-free tire build cum vulcanization.

An advantageous hybrid cord is obtained when the low-modulus yarn is a yarn in polyester or polyamide and/or when the high-modulus yarn is a yarn in aramid or glass or carbon.

An advantageous way to achieve reliable adherence to rubber is for the adhesion promoter used to be resorcinol-formaldehyde latex (RFL), an isocyanate-type adhesive system or epoxy resin.

It is also preferable for the high-modulus yarn or yarns of the hybrid cord to have a cumulative fineness of not more than 250 dtex. Preferably, in this embodiment, the cumulative fineness of the low-modulus yarn or yarns have a cumulative fineness of not more than 250 dtex.

It is also preferable for the hybrid cord to be constructed of a yarn in aramid and a further yarn in PES, or of a yarn in aramid and a further yarn in PA. It is also preferable when the hybrid cord comprises an aramid yarn having a fineness of not more than 250 dtex, preferably having a fineness of not more than 220 dtex.

When the above-described hybrid cord is used as a strength member in further elastomeric articles of manufacture such as a pneumatic vehicle tire, a conveyor belt, a drive belt, a hose and/or an air spring lobe, it is the reduced height of the strength member ply coupled at the same time with advantageous force-elongation behavior that yields advantages.

On using an above-described hybrid cord as a strength member of the belt bandage of a pneumatic vehicle tire, the tire has improved durability and makes a trouble-free tire build cum vulcanization and also a reduced level of rolling resistance possible.

Exemplary embodiments and further advantages of the invention will now be more particularly described in conjunction with tables 1 to 3.

Table 1 gives some examples of hybrid cords according to the invention, which are referred to as hybrid cords I, II, III and IV. Said hybrid cords each comprise a 220 dtex aramid yarn Z-twisted at 550 T/m. The hybrid cords each comprise a further yarn Z-twisted at 550 T/m. The two yarns are folded together in the S-direction at 550 T/m to form the hybrid cord. The further yarn of hybrid cord I is a yarn in PA 66 of 470 dtex fineness, the further yarn of hybrid cord II is a yarn in PA 66 of 275 dtex fineness, the further yarn of hybrid cord III is a yarn in PET of 550 dtex fineness and the further yarn of hybrid cord IV is a yarn in PET of 238 dtex fineness.

TABLE 1

| Hybrid cord I | Hybrid cord II | Hybrid cord III | Hybrid cord IV |
|---|---|---|---|
| aramid 220 x1 + | aramid 220 x1 + | aramid 220 x1 + | aramid |
| PA 66 470 x1 | PA 66 235 x1 | PET 550 x1 | 220 x1 + |
| | | | PET 238 x1 |

The hybrid cords are provided an RFL dip as adhesive impregnation. In the processes of adhesive impregnation, the hybrid cord was then dried at a temperature of 100° C. to 200° C. under a tensile stress, thereafter hot drawn at a temperature of 200° C. to 250° C. under a tensile stress and, after hot drawing, relaxed at from 100° C. to 200° C. under a tensile stress. The tensile stress in each case is reported in table 2.

TABLE 2

| | | Hybrid cord | Hybrid cord | Hybrid cord |
|---|---|---|---|---|
| | Hybrid cord I | II | III | IV |
| | tensile stress | tensile stress | tensile stress | tensile stress |
| | [mN/tex] | [mN/tex] | [mN/tex] | [mN/tex] |
| drying | 13 | 20 | 13 | 17 |
| hot drawing | 20 | 29 | 17 | 22 |
| relaxation | 6 | 11 | 4 | 4 |

The aforementioned hybrid cords were used to obtain force-elongation data as per ASTM D 855M which are shown in table 3. The hybrid cords all have a breaking extension of not less than 5%.

TABLE 3

| | Hybrid cord | Hybrid cord | Hybrid cord | Hybrid cord |
|---|---|---|---|---|
| | I | II | III | IV |
| breaking | 6.9% | 5.7% | 7.0% | 5.3% |
| extension | | | | |
| breaking force | 68 N | 60 N | 70 N | 55 N |
| force at 2% | 12 N | 13 N | 17 N | 16 N |
| elongation | | | | |
| force at 4% | 28 N | 35 N | 32 N | 37 N |
| elongation | | | | |

The low fineness of such hybrid cords makes possible the production of thin strength member plies for elastomeric articles of manufacture. When such a strength member is used in the belt bandage of a pneumatic vehicle tire, therefore, the rolling resistance of the pneumatic vehicle tire is reduced. Yet, despite the low fineness, durability is safeguarded and a trouble-free tire build cum vulcanization is ensured.

What is claimed is:

1. A strength member for elastomeric articles of manufacture, wherein the strength member is a hybrid cord comprising at least one low-modulus yarn having an modulus of elasticity of not more than 100 mN/(tex·%) and at least one high-modulus yarn having an modulus of elasticity of not less than 200 mN/(tex·%), according to ASTM D885M at an elongation of 3%, wherein all the yarns of the hybrid cord are folded together and wherein the hybrid cord is provided an adhesive impregnation, and wherein:
the low-modulus yarn or yarns has or have a cumulative fineness of not more than 550 dtex, preferably a cumulative fineness of not more than 250 dtex;
the high-modulus yarn or yarns has or have a cumulative fineness of not more than 550 dtex, preferably a cumulative fineness of not more than 250 dtex; and,
the hybrid cord has a breaking extension of not less than 5%.

2. The strength member as claimed in claim 1, wherein the hybrid cord comprises a low-modulus yarn in polyester (PES) and/or a low-modulus yarn in polyamide (PA).

3. The strength member as claimed in claim 1, wherein the hybrid cord comprises a high-modulus yarn in aramid and/or a high-modulus yarn in carbon and/or a high-modulus yarn in glass.

4. The strength member as claimed in claim 1, wherein the hybrid cord is constructed of a yarn in aramid and a further yarn in PES, or of a yarn in aramid and a further yarn in PA.

5. The strength member as claimed in claim 1, wherein the hybrid cord comprises an aramid yarn having a fineness of not more than 220 dtex.

6. The strength member as claimed in claim 1, wherein the yarns of the hybrid cord are folded together using a twist factor α of 80 to 200, preferably using a twist factor α of 100 to 150.

7. The strength member as claimed in claim 1, wherein the hybrid cord has been hot-drawn under a tensile stress of not more than 60 mN/tex, preferably under a tensile stress of not more than 40 mN/tex.

8. The strength member as claimed in claim 1, wherein the modulus of elasticity of the hybrid cord at 3% elongation to ASTM D885M is from 80 mN/(tex·%) to 300 mN/(tex·%), preferably from 100 mN/(tex·%) to 200 mN/(tex·%).

9. The strength member as claimed in claim 1, as used as a strength member of a pneumatic vehicle tire, of a conveyor belt, of a drive belt, of a hose and/or of an air spring lobe.

10. The strength member as claimed in claim 1, as used as a strength member of the belt bandage of a pneumatic vehicle tire.

11. A method of producing a strength member for elastomeric articles:
wherein the strength member is a hybrid cord comprising at least one low-modulus yarn having an modulus of elasticity of not more than 100 mN/(tex·%) and at least one high-modulus yarn having an modulus of elasticity of not less than 200 mN/(tex·%), each to ASTM D885M at an elongation of 3%,
wherein all the yarns of the hybrid cord are folded together,
wherein an adhesion promoter is applied to the hybrid cord,
wherein the hybrid cord is then dried at a temperature of from 100° C. to 200° C.,
wherein the hybrid cord is hot-drawn at a temperature of from 200° C. to 250° C. after drying,
wherein the hybrid cord relaxes at from 100° C. to 200° C. under a residual stress after hot drawing,
wherein the low-modulus yarn or yarns has or have a cumulative fineness of not more than 550 dtex, preferably a cumulative fineness of not more than 250 dtex,
wherein the high-modulus yarn or yarns has or have a cumulative fineness of not more than 550 dtex, preferably a cumulative fineness of not more than 250 dtex,
wherein the hybrid cord is exposed to a tensile stress of from 5 to 50 mN/tex, preferably to a tensile stress of from 10 mN/tex to 30 mN/tex, during drying,
wherein the hybrid cord is exposed to a tensile stress of from 10 mN/tex to 60 mN/tex, preferably to a tensile stress of from 15 mN/tex to 40 mN/tex, whilst undergoing hot drawing, and
wherein the hybrid cord relaxes under a tensile stress of from 0 mN/tex to 30 mN/tex, preferably from 3 mN/tex to 15 mN/tex.

12. The method as claimed in claim 11, wherein the low-modulus yarn is a yarn in polyester or polyamide and/or in that the high-modulus yarn is a yarn in aramid or glass or carbon.

13. The method as claimed in claim 11, wherein the adhesion promoter used is resorcinol-formaldehyde latex (RFL), an isocyanate-type adhesive system or epoxy resin.

14. The method as claimed in claim 11, wherein the strength member is used as a strength member of a pneumatic vehicle tire, of a conveyor belt, of a drive belt, of a hose and/or of an air spring lobe.

15. The method as claimed in claim 11, wherein the strength member is used as a strength member of the belt bandage of a pneumatic vehicle tire.
